(19) United States
(12) Patent Application Publication
(10) Pub. No.: US 2015/0213220 A1
(43) Pub. Date: Jul. 30, 2015

(54) MONITORING PATIENT HEALTH

(71) Applicant: Prevail Holdings Inc., Lafayette, LA (US)

(72) Inventor: Kevin A. COURVILLE, Lafayette, LA (US)

(21) Appl. No.: 14/610,603

(22) Filed: Jan. 30, 2015

Related U.S. Application Data
(60) Provisional application No. 61/933,546, filed on Jan. 30, 2014.

(51) Int. Cl. G06F 19/00

(52) U.S. Cl. CPC G06F 19/3431; G06F 19/3418

(57) ABSTRACT

A system and associated methods are provided monitoring patient health. A composite risk score is computed based upon the relevance of a set of risk factors to a patient. The composite risk score is then used to select one of a plurality of sets of health data thresholds. Measurements that exceed thresholds of the selected set of thresholds cause an alert to be generated to prompt medical intervention.

### CROSS-REFERENCE TO RELATED APPLICATIONS

This application claims priority to U.S. Provisional Patent Application No. 61/933,546 filed Jan. 30, 2014, which is incorporated herein by reference.

### BACKGROUND OF THE INVENTION

It is a common practice during hospitalization of a patient to monitor vital signs and other health metrics. Many monitoring devices provide alert functionality to inform hospital staff when a measured or monitored parameter has moved out of an expected range, such that intervention may be initiated.

However, once a patient has been discharged, regular monitoring generally ceases. Since there are far more patients diagnosed that require specialized treatment for their condition than there are providers specializing in the treatment of these conditions, it is impractical for providers to check on each patient at short intervals. Further assessment of the patient's condition generally involves the patient returning for follow-up visits. If a patient fails to return for assessment, however, minor medical issues that could be corrected with simple intervention may escalate into major medical issues requiring more significant intervention.

Furthermore, in some cases, health care providers may receive severely reduced fees for treatment, or face monetary penalties, if a patient is readmitted for the same condition for which he or she was recently treated. It is therefore also financially beneficial to the health care provider to reduce readmissions.

Periodic measurement of patient health data and comparison to acceptable thresholds after discharge could be used to provide earlier detection of problems. A single set of thresholds, however, is not sufficient for use with all patients. Depending on the severity of chronic conditions or the progression of a disease, a patient my consistently exhibit health data measurements that are outside of normal ranges, but not indicative of a need for additional intervention for that patient. The use of uniform thresholds would therefore lead to unnecessary intervention and increased costs.

What is needed is a system for monitoring patient health that is responsive to the individual medical situation of each patient.

### SUMMARY OF THE INVENTION

A system and associated methods are provided monitoring patient health. A composite risk score is computed based upon the relevance of a set of risk factors to a patient. The composite risk score is then used to select one of a plurality of sets of health data thresholds. Measurements that exceed thresholds of the selected set of thresholds cause an alert to be generated to prompt medical intervention. The system thereby allows a health care provider to monitor and treat a much larger patient population than he or she could accomplish without the use of such technology. The system may further provide physician education to allow a non-specialist to provide the same evidence-based care a specialist would provide.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there are shown in the drawings embodiments that are presently preferred. It should be understood, however, that the invention is not limited to the precise arrangements and instrumentalities shown.

FIG. 1 is a system diagram of a system for monitoring the health of patients;

FIG. 2 is a flowchart of an exemplary process for selecting thresholds for use in monitoring a particular patient using the system of FIG. 1;

FIG. 3 is a flowchart of an exemplary process for selecting thresholds for use in monitoring a particular patient using the system of FIG. 1;

FIG. 4 is a block diagram of an exemplary user interface for entry of patient health data into the system of FIG. 1 at a computing device;

FIG. 5 is a block diagram of an exemplary user interface of a mobile application for allowing entry of patient heath data for submission to the system of FIG. 1;

FIG. 6 is a block diagram of an exemplary user interface of a mobile application of the system of FIG. 1 for providing notice of alerts to a monitoring health care provider; and

FIG. 7 is an exemplary sequence diagram of interactions between mobile applications on mobile devices and the health monitoring system server of FIG. 1.

### DETAILED DESCRIPTION OF THE PREFERRED EMBODIMENTS

Certain terminology is used in the following description for convenience only and is not limiting. The words “right”, “left”, “lower”, and “upper” designate directions in the drawings to which reference is made. The terminology includes the above-listed words, derivatives thereof, and words of similar import. Additionally, the words “a” and “an”, as used in the claims and in the corresponding portions of the specification, mean “at least one.”

The present disclosure relates generally to a system for monitoring patient health and providing alerts to medical providers when patient data suggests that intervention is necessary. The system preferably selects patient-specific thresholds for generation of alerts responsive to health information regarding the specific patient.

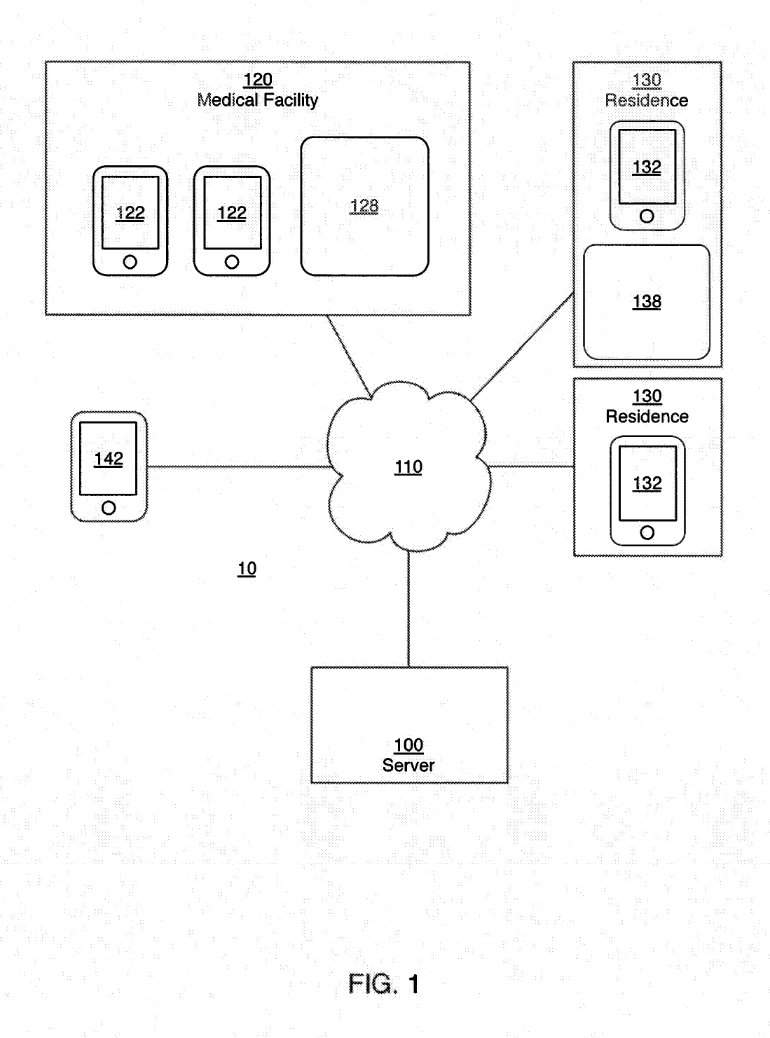

Referring to the drawings in detail, wherein like reference numerals indicate like elements throughout, FIG. 1 is a system diagram of a system 10 for monitoring the health of patients. A server 100 provides centralized storage and monitoring of health data, as well as functions related to providing alerts based upon health data. While the server 100 is shown as a single entity, it is to be understood that server 100 may be implemented by any combination of computing devices, including one or more physical or virtual servers. The servers preferably implement an N-tier server infrastructure having one or more application servers, one or more web servers, and one or more database servers. The servers or server components may communicate with each other over a local area or wide area network, not shown, or, in some cases, a network 110, which may comprise portions of the Internet. The servers may be implemented using purpose-built or general purpose computing hardware, comprising processors for execution of program code for performing the processes described below, memory for storing program code and data, and interfaces for communications. Furthermore, any of the servers may utilize separate database servers for storage and retrieval of data, as well as other specialized servers or devices for other functions.

In an implementation for monitoring heart health, the server 100 preferably incorporates a database to store patient medical profiles, co-morbidities, health data, and heart failure classification and stage into an algorithm that generates unique directives for that patient. In a preferred embodiment, the system acts as both an evidence-based guide for physicians for treating and managing heat failure, as well as a remote heart management and communication tool for the patients individualized care. Remote management and communication functionality is utilized by patients caregivers and providers to provide access to such functions.

Mobile devices 122 and one or more computers 128 at a medical facility 120 connect to the server 100 over network 110 to provide and retrieve data, including patient and health care provider information and health data. A single server 100 may provide monitoring services related to multiple medical facilities 120, and any number of mobile devices 122 and computers 128 may be utilized.

Additional mobile devices 132 or computers 128 may be utilized at patient residences 130 for submission of patient health data and receipt of communications from the system 10. Mobile device 142 may be carried by a healthcare provider monitoring alerts from the server 100. Any of mobile devices 122, 132, and 142 may communicate with the server 100 via a variety of, and combination of, networks, including wired or wireless local area networks, wide-area networks, cellular networks, and the Internet.

It is to be understood that FIG. 1 is merely an exemplary figure of a deployment of the system. Different numbers of medical facilities 120, residences 130, mobile devices 122, 132, and 142, computers 128, and networks 110 may be utilized within the scope of the invention. Furthermore, computers 128 may also be used in other locations by patients, medical personnel, or operational personnel.

The system 10 may utilize a variety of account types to allow and restrict functions for particular users. A super-administrator account is preferably provided to allow personnel to set up clinics and their administrators, view key reports, and perform monthly billing. In a heart health monitoring implementation, the system preferably provides reporting functionality, such as NYHA classification change, change in heart failure stage, and hospital readmits within 30 days. The super-administrator can preferably search for and select a clinic that is already in the system to add or deactivate clinic administrators as needed. The super-administrator preferably provides login credentials after the clinic is set up to set up the clinic administrator.

After logging in, the clinic administrator sets up provider accounts for providers who are responsible for inputting the patient information required to enroll patients into the system 10 for individualized care for health monitoring for conditions such as heart failure.

A clinic administrator preferably has the ability to deactivate and reactivate providers as needed. The clinic administrator is also preferably provided the ability to modify clinic communication settings, such as to assign all communications to one recipient or assign communications to different providers and reassign them as needed. In a preferred embodiment, users may be categorized at setup as providers, nurses, or home care agency personnel. Clinic administrators will preferably add the hospitals and pharmacies and home care agencies with which the clinic is affiliated.

Each patient is preferably enrolled in the system 10 by an assigned provider or nurse at a medical facility or clinic 120. General patient information is input and the assigned provider or nurse inputs the past hospital or clinic encounters, cardiologist, primary care physician, patient contact information, medical history, heart failure stage and classification, social history, medications, and dry weight. Some or all of this information is used in the selection of alert thresholds for the patient, as will be described further below.

After information has been entered, the provider can preferably view a complete dashboard for the patient and edit information as needed. A medical profile view may be provided after the profile of the patient has been saved.

After the patient is enrolled, the patient or caregiver may be sent an email with a user name and a link to register. The user may then be required to accept a license agreement and set a password. The patient or caregiver may login via the web on a computer or tablet or download a mobile application for use with the system 10. In a preferred embodiment, applications are provided for the iOS and Android operating systems.

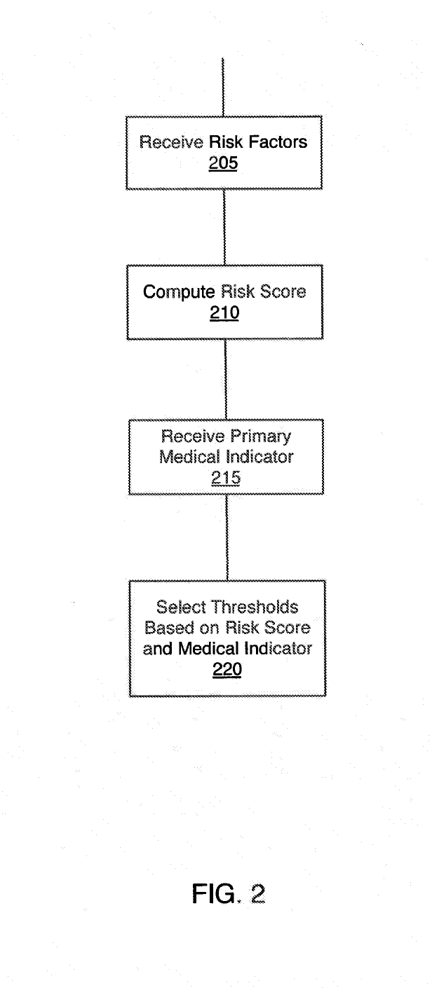

FIG. 2 is a flowchart of an exemplary process for selecting thresholds for use in monitoring a particular patient using the system 10 of FIG. 1. At 205, the system receives information regarding risk factors for the patient. In a heart health monitoring implementation, risk factors may preferably include diagnoses or conditions such as chronic kidney disease, hypertension, diabetes, ventricular tachycardia, coronary artery disease, peripheral artery disease, New York Heart Association heart failure class III or IV, atrial fibrillation, or supraventricular arrhythmia.

The risk factor data may be received or entered in a variety of ways. Some data may be available from a patient's chart or an electronic medical record system. In some cases, some or all data may be acquired from the patient during an intake process, either verbally, via written form, or via an application or web page. Data may be entered directly by the patient or by staff involved in the health monitoring function. In some cases, the data may be obtained using medical tests such as an echocardiogram, urinalysis, or serum creatinine test.

At 210, a composite risk factor score is computed. In a preferred embodiment, each risk factor is assigned a number of points for use in a summing operation used to produce the composite risk factor score. In a preferred embodiment of a heart health monitoring implementation, the presence of chronic kidney disease with a glomerular filtration rate below 60, diabetes, ventricular tachycardia, New York Heart Association heart failure class III or IV, atrial fibrillation, and supraventricular arrhythmia may each be assigned two points, whereas hypertension, coronary artery disease, and peripheral artery disease may be assigned a single point. In other embodiments, contribution of each condition to the risk score may be computed mathematically based upon a metric associated with the condition.

At 215, a primary medical indicator for the patient is received. In a heart health monitoring application, in a preferred embodiment, the primary medical indicator is ejection fraction, a measurement of the percentage of blood leaving the heart each time it contracts.

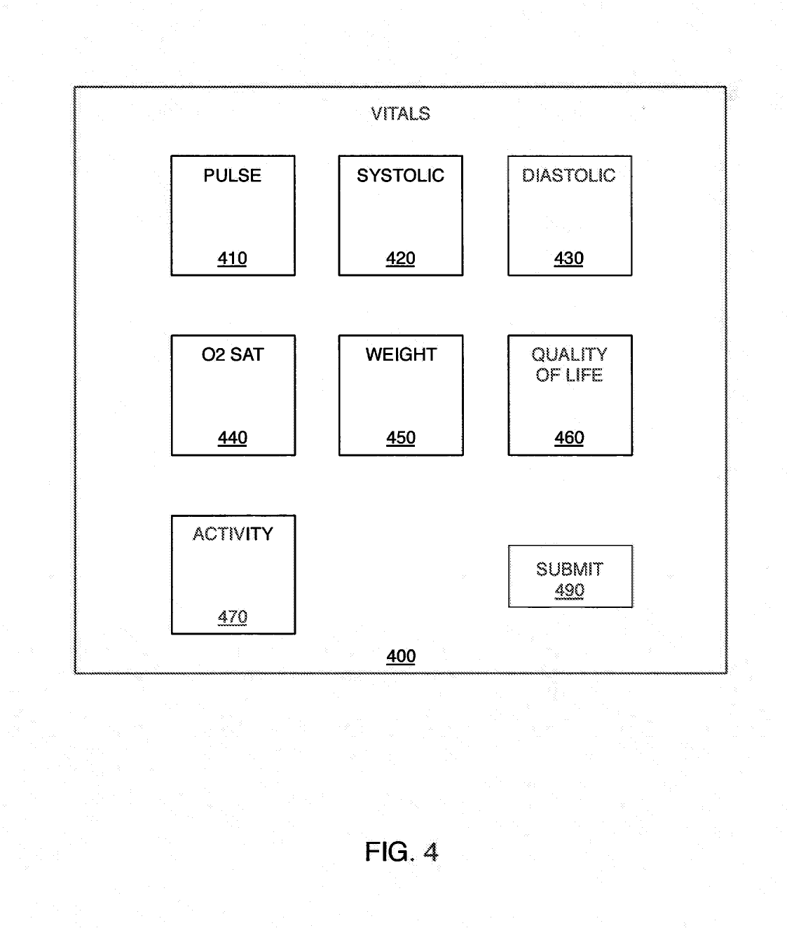

At 220, the primary medical indicator and composite risk factor score are used to select a set of thresholds for use in monitoring the patient. A more detailed example of the selection process is described below with respect to FIG. 4.

It is to be understood that while the steps are shown in a particular order, the order of some steps may be changed. For example, 215 may be performed at various points before or after steps 205 or 210.

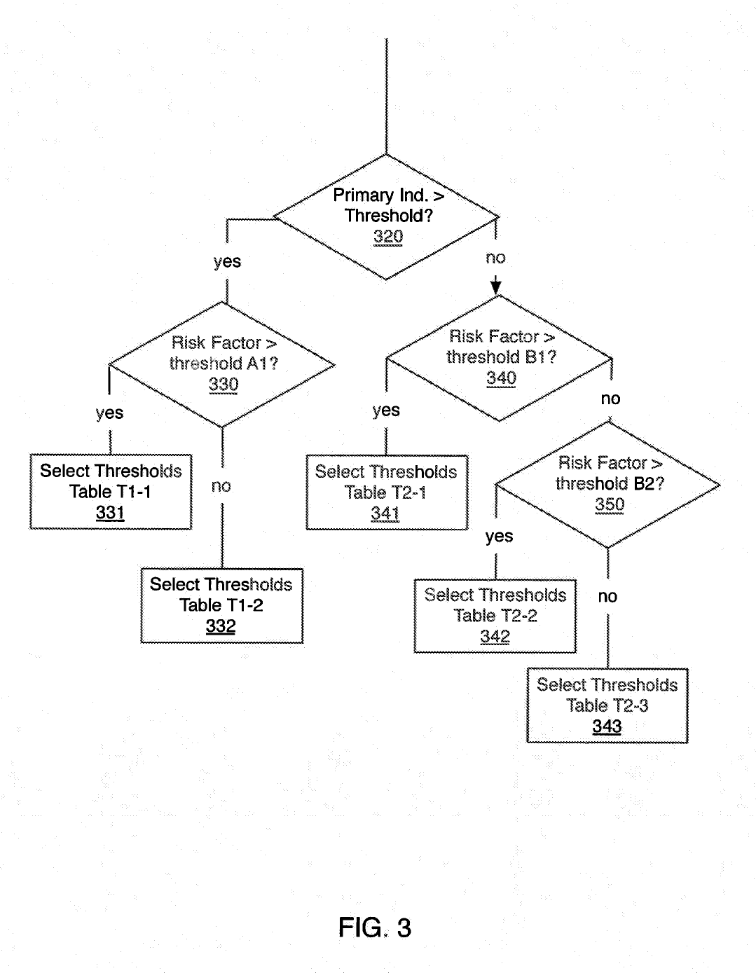

FIG. 3 is a flowchart of an exemplary process for selecting thresholds for use in monitoring a particular patient using the system 10 of FIG. 1. The flowchart is one example of a selection process 220 of FIG. 2 above.

At 320, a determination is made as to whether the primary medical indicator is above a threshold. In a preferred embodiment of a heart health monitoring implementation, the patient's ejection fraction percentage is compared to a 45% threshold.

If at 320, the primary medical indicator received at 215 is determined to be above a threshold, a determination is made at 330 as to whether the composite risk factor score is above a threshold A1. For instance, in a preferred heart health monitoring implementation, the patient's composite risk factor score, computed at 210, may be compared against a threshold of 3, as described above.

If, at 320, the composite risk factor score is above the threshold A1, a table of thresholds T1-1 is selected at 331. If the composite risk factor score is not above threshold A1, a table of thresholds T1-2 is selected at 332. While, in this example, two tables of thresholds are available in cases where the primary medical indicator is above its threshold, any number of threshold tables may be made available for selection based on various ranges of composite risk factor score computed at 210.

For instance, in the example of FIG. 3, if the primary medical indicator received at 215 is not above the threshold at 320, selection from amongst three different tables is made via comparisons at 340 and 350. A determination is made at 340 as to whether the composite risk factor score, computed at 210, is above a threshold B1. If so, a table of thresholds T2-1 is selected at 341. If not, an assessment of the composite risk factor score against a threshold B2 s made at 350. If the composite risk factor score is above B2, a table of thresholds T2-2 is selected at 342. If not, a table of thresholds T2-3 is selected at 343.

While in this example, five different potential tables of health data thresholds may be chosen, it is to be understood that this is merely an example and other numbers of tables may be utilized based on the granularity desired in controlling alerts. Furthermore, while different tables may be selected, some thresholds of those tables may comprise common values. For instance, in a preferred heart health monitoring embodiment, all tables may comprise a weight-change threshold of three pounds from the patient's baseline weight. The tables may differ, for instance, in the systolic blood pressure required to trigger an alert, or in a percentage change in systolic blood pressure that will trigger an alert.

It is to be understood that the selection of tables may be performed using lookups instead of explicit comparisons of the primary medical indicator or composite risk factor score to thresholds. It is also to be understood that while the comparisons have been described with respect to a patient metric being above a threshold, equivalent implementations may use “less-than,” “less-than or equal to,” or “greater-than or equal to” comparisons, or use lookup tables based on the risk score or primary medical indicator value to determine an address or identifier of a table of thresholds to be used.

As would be understood by one skilled in the art, the assessment of whether the primary medical indicator and the assessment of the composite risk factor score may be performed in either order in the determination of which set of thresholds are to be used. Furthermore, the number of thresholds that are compared at each health measurement interval may vary based upon the primary medical indicator and the composite risk factor score.

FIG. 4 is a block diagram of an exemplary user interface 400 for entry of patient health data into the system 10 of FIG. 1 at a computing device. Such a user interface 400 may be used, for instance, on a computer 128 during a patient intake process at a medical facility 120.

It is to be understood that the layout 400 shown in FIG. 4 is arbitrary and may be modified, including providing multiple screens for entry of individual data items or subsets of those items. It is also to be understood that the health data metrics shown are examples related to a preferred embodiment of a heart health monitoring implementation. Other metrics may be substituted both for heart health and other implementations.

The exemplary user interface 400 provides fields for entry of pulse 410, systolic blood pressure 420, diastolic blood pressure 430, oxygen saturation 440, weight 450, a quality of life measure 460, and an activity level 470. Other metrics, such as respiratory rate, may be added to, or substituted for, the exemplary metrics.

A submission button 490 is provided for submission of the data after entry. The system preferably will disable submission button 490 until all required data have been entered, or present a warning dialog if submission is attempted before all required data has been entered. After entering the health data, the patient or caregiver may be prompted by the system to make sure that the data entered are correct before submission. If any parameter is out of an expected range the system will preferably trigger an alert to the provider.

To increase the convenience of entering health data, and in turn, increase compliance, the system 10 preferably provides mobile applications for entry of data. In a preferred embodiment, applications are provided for the iOS and Android operating systems.

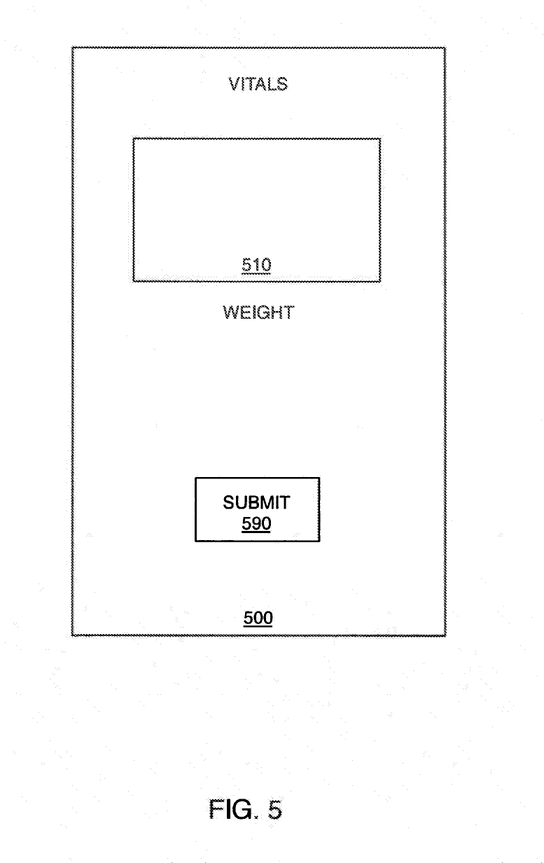

FIG. 5 is a block diagram of an exemplary user interface 500 of a mobile application for allowing entry of patient heath data for submission to the system 10 of FIG. 1. The user interface 500 may be presented by a mobile application stored and executed on, for instance, mobile devices 122, 132, and 142, and may transmit data over network 110 to server 100.

Due to the limited display space available to many mobile applications, the user interface may be configured to allow entry of a single piece of health data at a time. As shown in user interface 500, a dialog box 510 for entry of weight is shown along with a button 560 for submission of the data once entered. The mobile application may then present a dialog for entry of the next health metric, or, after entry of all required data, submit the data to server 100. For instance, in a heart health monitoring system, the mobile application may sequentially present dialogs for entry of pulse, systolic blood pressure, diastolic blood pressure, oxygen saturation, respiratory rate, weight, a quality of life measure, and an activity level.

In some embodiments, some or all of the required data may be acquired automatically from sensors worn or used by the patient. For instance, Bluetooth communication may be used to retrieve weight data from a scale or blood pressure information from a sphygmomanometer.

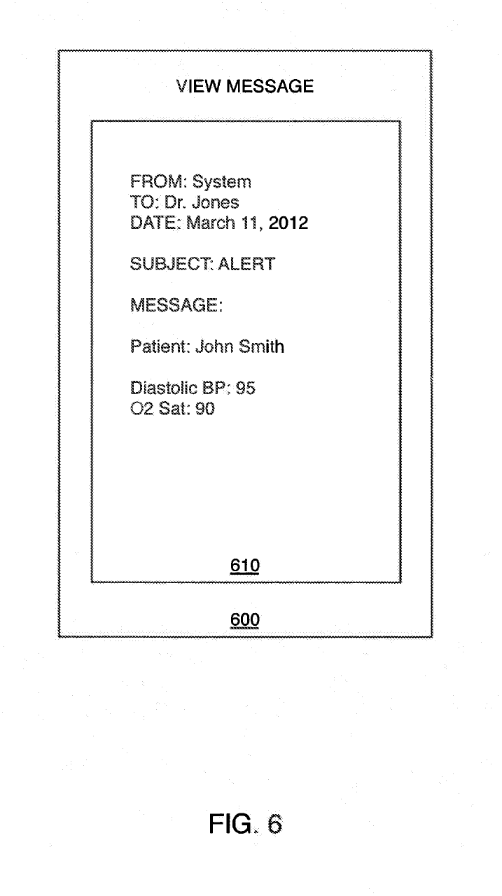

FIG. 6 is a block diagram of an exemplary user interface 600 of a mobile application of the system of FIG. 1 for providing notice of alerts to a monitoring health care provider. In the example of FIG. 6, the alert 610 is presented on user interface 600 of a mobile application executed on a mobile device 142. In other embodiments, or as an alternative in the same embodiment, the user interface may be presented in a web browser. The alert may be received by mobile device 142 via network 110.

Alerts may comprise one or more of email messages, text messages, mobile application notifications, social networking messages, phone messages, or any other means of conveying information. In the case of mobile device application notifications, for instance, the alerts may be routed through one or more third parties, such as Apple Inc., in the case of iOS applications, or Google Inc., in the case of Android applications.

After receiving the alert, the health care provider opens the communication via the mobile application or in a web browser. The provider is presented with information regarding which health metric is out of range, and preferably which medications have been prescribed, a pharmacy contact, and the patient contact. The provider may then respond via the system 10 to the patient or call the patient directly. The provider may also forward messages to other providers for consultation. The person receiving the forwarded alert is then preferably required to log into the system 10 to view the message.

In many cases, health information privacy laws, such as the Health Insurance Portability and Accountability Act of 1996 (HIPAA) may restrict the amount of information that may be conveyed directly in an alert. In such cases, the alert is preferably configured to provide a link to the secure server 100 where the information may be viewed.

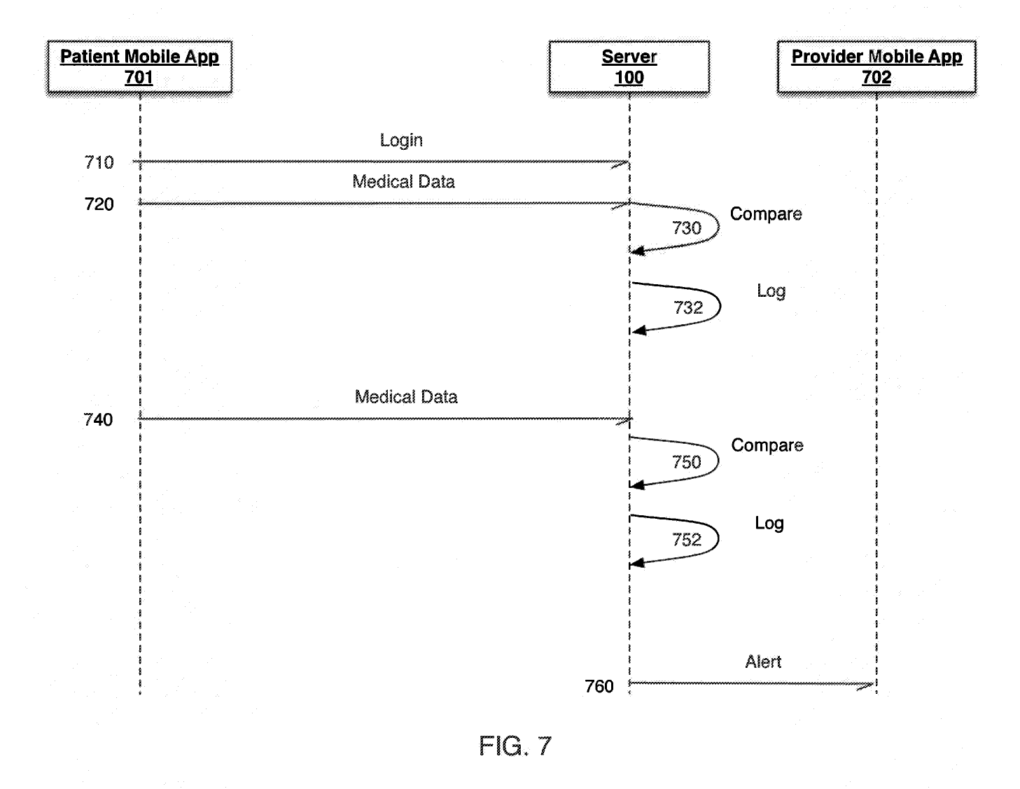

FIG. 7 is an exemplary sequence diagram of interactions between mobile applications 701 and 702 on mobile devices and the health monitoring system server 100 of FIG. 1. While the example is described with respect to At 710, login information is sent from patient mobile application 701 running on mobile device 132 to server 100. The login process may involve multiple exchanges of data between mobile application 701 and server 100. Server 100 may, in some embodiments, validate user credentials with a separate server.

At 720, a first set of medical data entered by the patient or caregiver is sent from mobile application 701 to server 100. In some embodiments, individual data items may be sent in separate communications as the patient enters them. In other embodiments, a full set of data is transmitted in a single communication. The patient or a caregiver may enter the data, for instance, using a user interface such as user interface 500 on mobile device 132, and the data may be transmitted over network 110.

At 730, the server compares the received patient health data with the thresholds selected for that patient. The thresholds are preferably selected via a process such as the process shown in FIG. 2 and FIG. 3.

In a preferred embodiment, as association between a patient and set of thresholds is determined at enrollment and at other times when risk factors or key medical indicators change. However, in some embodiments, stored data regarding risk factors and key medical indicators may be checked upon each receipt of patient data for a determination of the appropriate set of thresholds to use in the comparison.

If, at 730, none of the patient health data items are outside of their selected thresholds for that patient, the server does not issue alerts. The system, however, preferably logs or stores the received data at 732 for use, for instance, in historical analysis or trend analysis.

At 740, a second set of medical data entered by the patient is sent from mobile application 701 to server 100. As described above, in some embodiments, individual data items may be sent in separate communications as the patient enters them. In other embodiments, a full set of data will be transmitted in a single communication. The patient or a caregiver may enter the data, for instance, using a user interface such as user interface 500 on mobile device 132, and the data may be transmitted over network 110.

At 750, the server compares the received patient health data with the thresholds selected for that patient. As described above, the thresholds are preferably selected via a process such as the process shown in FIG. 2 and FIG. 3. The system also preferably stores the received data at 752 for use, for instance, in historical analysis or trend analysis.

If, at 750, at least one of the patient health data items is outside of its selected threshold or thresholds for that patient, the server issues an alert at 760. The alert is sent to a mobile application 702 running on a health care provider mobile device 142. The system preferably looks up previously stored data regarding the health care provider or providers to be notified in the event of an alert for that patient, looks up preferred contact methods and addresses for those providers, and issues one or more alerts. Notification of the alert may also be sent to the patient and caregivers in some embodiments. Alerts are also preferably logged in a system database. The system 10 may also provide reporting capability for aggregate listing of alerts generated for multiple patients over a specified period of time, as well as provide functionality for tracking actions taken in response to alerts. Patient alerts are also saved in the system 10, preferably at server 100, in a manner that allows the provider to log in, view, and address multiple alerts at one time, in addition to allowing the provider to address alerts individually as they are transmitted by the system. The provider may also be provided with the ability to review the patients' medical information within the system while reviewing and addressing any alerts generated by the system.

In some embodiments, alerts may also be generated upon failure of the patient or caregiver to submit health data by a predetermined time, such as 6PM each day, or for a predetermined amount of time, such as 48 hours. In some cases, initial alerts regarding non-compliance with reporting requirements may be sent to the patient or caregivers, whereas alerts regarding repeated non-compliance, such as over a one week period, may be sent to the provider.

The system 10 may additionally provide health care provider education functionality that allows the provider, for instance, to bring up linked studies and white papers that present guidelines for evidence-based treatment decisions. Documents may be stored, for instance, on server 100 or at other locations on the Internet. This functionality provides non-specialist providers with the resources needed to practice as a specialist would, using evidence-based, best practice recommendations.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A system for performing monitoring patient health comprising:
a memory that stores program code and data;
at least one interface configured to receive and transmit data;
a processor configured to execute program code from the memory including performing the steps of:
storing data associating a patient with a healthcare provider;
receiving information regarding risk factors associated with the patient;
computing a composite risk factor score for the patient based at least in part upon the received information regarding risk factors associated with the patient;
receiving primary medical indicator data associated with the patient;
selecting a set of health data thresholds from a plurality of sets of health data thresholds, the selection based at least in part upon the computed composite risk factor score and the received primary medical indicator;
receiving a plurality of health data values associated with the patient;
comparing each of the plurality of health data values against a corresponding threshold of the selected set of health data thresholds; and
responsive to a determination that at least one of the health data values exceeds its corresponding health data threshold of the set of health data thresholds selected based at least in part upon the composite risk factor score and the primary medical indicator, sending an alert to an address associated with the healthcare provider associated with the patient.

2. The system of claim 1 wherein the primary medical indicator data is ejection fraction.

3. The system of claim 1 wherein the information regarding risk factors associated with the patient comprises information regarding whether a patient has been diagnosed with each of a plurality of conditions.

4. The system of claim 1 wherein the plurality of health data values comprises at least two of: heart rate, systolic blood pressure, diastolic blood pressure, blood oxygen saturation level, respiratory rate, and weight.

5. The system of claim 1 wherein the set of thresholds comprises at least two of: a minimum heart rate, a maximum heart rate, a systolic blood pressure, a diastolic blood pressure, a blood oxygen saturation level, a minimum respiratory rate, a maximum respiratory rate and a weight difference from a baseline weight.
